(19) United States
(12) Patent Application Publication
(10) Pub. No.: US 2003/0167131 A1
(43) Pub. Date: Sep. 4, 2003

(54) Method for constructing, representing or displaying protein interaction maps and data processing tool using this method

(76) Inventors: Yvan Chemama, Paris (FR); Fabien Petel, Orsay (FR); Jerome Wojcik, Paris (FR)

Correspondence Address: Blakely Sokoloff, Taylor & Zafman, 7th Floor, 12400 Wilshire Boulevard, Los Angeles, CA, 90025, US

(21) Appl. No.: 10/257,591

(22) PCT Filed: Apr. 13, 2001
(86) PCT No.: PCT/IB01/00875

(51) Int. Cl. G06F 19/00

(52) U.S. Cl. 702/19

(57) ABSTRACT

An interaction map construction and representation method in which references of proteins are represented with links corresponding to alleged interactions between said proteins, wherein a score representing the significance of the protein-protein interaction is determined for each interaction and the scores of the represented interactions are indicated on the interaction map in the vicinity of the interactions to which they correspond.

The present invention relates to a method for constructing, representing or displaying protein interaction maps and to a data processing tool which uses this method.

### I. GENERAL FIELD OF THE INVENTION

The present invention relates to the field of computer systems, especially to computational biology and proteomics for visualizing protein-protein interaction maps. Improved computer systems are needed to evaluate, analyse and process the vast amount of biological information now used and made available thanks to proteomics technologies.

The proteomics approach offers great advantages for identifying protein function and response to therapy and for identifying protein targets for the prevention and treatment of disease.

The present invention allows proteome-wide characterisation and visualisation of protein interactions, the identification of the specific interacting domain of proteins and determination of a biological score relevance of the interaction. As a consequence, the below described invention helps improvement of knowledge of functional analysis of genes and proteins in micro-organisms, bacteria, viruses, plant cells and animal cells (mammalian, amphibian, insect . . . ).

One particular application of the present invention is to identify drug target by the comprehension of disease pathway and the isolation of essential proteins of the pathway. These drug targets may be used to screen small molecules that are tested for the purpose of drug development.

Another application of this method is the characterisation of protein network and improvement of plant engineering.

### II. PRIOR ART BACKGROUND AND AIM OF THE INVENTION

Bioinformatics is an emerging discipline since the huge development of genomics—discipline of mapping, sequencing and analysing genomes—and proteomics—which is the study of protein properties (expression level, post-translational modification, interaction . . . ) on a large scale to obtain a global, integrated view of disease processes, cellular processes and network at the protein level, it is composed of expression proteomics and cell maps proteomics (Blackstock et al., 1999). Bioinformatics consists in the management and analysis of biological information stored in the databases (Jones et al., 2000).

Methods are already known for the identification, construction and display sets of protein interactions which show proteins and links between said proteins which correspond to identified interactions between them.

See for example “Toward a functional analysis of the yeast genome through exhaustive two hybrid screens”—M. Fromont-Racine, J. C. Rain, P. Legrain, Nature Genetics, volume 16, July 1997.

In this article, protein-protein interactions are identified using an improved version of the yeast two-hybrid system originally developed by Field et al. (1985): the Mating-Two Hybrid System.

Other technologies may be useful to identify protein-protein interactions and to:

the identification of interacting protein for cell surface receptors;

the identification of receptors for secreted proteins;

the identification of protein involved in host-pathogen interactions;

the identification of complexes for Structure-Activity-Relationship (SAR) studies;

these technologies include, but are not limited to, the two-plus-one hybrid system (Tirode et al., 1997), the reverse two-hybrid system (Vidal et al., 1996), the bacterial two hybrid system (Ladant et al., 1998), the one-hybrid system for the identification of interaction between DNA and protein (Wei et al., 1999), the three-hybrid system for the identification of interaction between RNA and protein (Zhang et al., 1997), this three-hybrid system may also be used to identification between protein and small chemical or organic molecules (Licitra et al., 1996) (for a global review of these “n-hybrid” systems, see Vidal and Legrain, 1999).

However, due to the huge mass of information which they convey, the protein interaction maps remain to the present date difficult to construct, read, represent, explore and interpret.

Current tools have limited capabilities in terms of integration of external data types and integration of statistical models of data generated by other technologies.

For example, the Munich Information Center for Protein Sequences (“mips”) proposes a list of yeast Saccharomyces cerevisiae protein-protein interactions in tables (see the mips web site at http://www.mips.biochem.mpg.de/proj/yeast/tables/interaction/index.html) but this web site does not display graphical representation of these protein-protein interactions.

The company Curagen proposes visualisation of yeast Saccharomyces cerevisiae protein-protein interactions maps in its Pathcalling tool (see web site at http://portal.curagen.com/extpc/com.curagen.portal.servlet.PortalYeastList). DIP (Database of Interacting Proteins) developed by Xenarios et al. (2000) proposes representation of protein-protein interactions (web address: http://dip.doe-mbi.ucla.edu/).

None of these current tools determine specific polypeptide domains involved in the interaction or biological score of the interactions.

There still remains a need for a bioinfomatics tool to provide confidence scores for all interactions, to identify the necessary domains for the protein interactions and to display these information:

with a simplified user friendly interface,

with optimized visualization and navigation,

allowing exploration of protein interaction maps,

permitting access to protein characteristics and biological pathways.

Furthermore, a great improvement of the existing displaying tool would allow the user to add its own biological, or proteomic, data (for example: 2D gel results, annotations, protein expression profiles, BRET technology, . . . ) and to add and/or update the annotation.

### III. PRESENTATION OF THE INVENTION

The present invention provides a relational database-based software solution for integrating, storing, and manipulating biological, proteomic, data and information which offers to the user the following capabilities:

construction and representation of protein-protein interaction map,

calculating of a biological score, the Predicted Biological Score PBS®,

determine the specific domain involved in a given interaction, the Selected Interacting Domain SID®.

The PBS score is computed as a combination of one or more “component scores”:

an internal score using only the Host proprietary data (Hybrigenics') which is computed in two steps:

determination of a local internal score derived for each protein-protein link;

determination of a global internal score combining local internal scores;

and at least an external score using data from outside sources.

The PBS scores are a probability value and are classified in categories (for example, five).

### IV. PRESENTATION OF THE DRAWINGS

The invention shall be further understood in view of the under presented detailed description which is to be read in relation with the following drawings:

FIGS. 1A is the functional architecture and 1B is a flow chart illustrating the architecture of a data processing tool according to the invention;

FIG. 2 is a screen displaying a protein interaction map according to the invention;

FIG. 3A is a screen displaying a PIM wherein PBS are scores and 3B is a screen displaying a PIM wherein PBS is a category.

FIG. 4 is a screen displaying all prey fragments identified in Two Hybrid System allowing the determination of a selected interacting domain according to the invention

FIG. 5 is a screen displaying several SID polypeptides interacting with NS3 protein (from HCV) and their position relating to the complete CDS;

FIG. 6 is a 3D visualisation of the NS3 protein (light grey) and the localisation of the SID (dark grey) interacting with E2 protein of HCV;

FIG. 7 is the MultiSID viewer of UreB protein of Helicobacter pylori;

FIG. 8 shows three screens relating to UreH protein of Helicobacter pylori;

FIG. 9A and FIG. 9B are PIM representation, FIG. 9A shows every interacting partners of UreA (Helicobacter pylori), FIG. 9B shows UreA with interacting partners after filtering on the PBS value (PBS of category A, B and C).

### V. DETAILED DESCRIPTION OF THE INVENTION

The present invention provides a relational database-based software solution for integrating, storing, and manipulating biological, proteomic, data and information which offers to the user the following capabilities:

construction and representation of protein-protein interaction map,

calculation of a reliability score, the Predicted Biological Score PBS® (see section V.2.2.),

determination of the specific domain involved in a given interaction, the Selected Interacting Domain SID® (see section V.2.3.).

Definitions

“Database” is the focus database of the present invention, it contains biological objects and may also contains information associated with biological object such as scientific publication.

An “external database” is a database located outside the Database, it may be used to obtain information about biological objects stored in the Database.

“Biological Object” comprises various biological entities such as organism, protein, gene, sequence, ORF, CDS, fragment, plate, bait-to-prey interactions, protein-protein interactions, SID, PIM.

An “ORF” (Open Reading Frame) corresponds to a nucleotide sequence which could potentially be translated into a polypeptide, this sequence is uninterrupted by a stop codon. An ORF that represents the coding sequence for a full protein begins with an ATG “start” codon and terminates with one of the three “stop” codons.

A “CDS” (CoDing Sequence) is a sub-sequence of a DNA sequence that encode a protein.

An “annotation” is a functional description of a biological object, which may include identifying attributes such as locus name, key words, bibliographical reference . . . .

“Protein interaction maps” are maps representing network of interactions between proteins and biological object such as other proteins, SID, RNA, DNA, chemical or organic small molecules, consequently, this term comprises protein-protein interaction map, protein-RNA interaction map . . .

“Flat files” are single files containing flat ASCII used for storing data.

“Internal data” are data generated by the Mating Two Hybrid technology or any other technologies allowing the identification of interactions between proteins, the determination of a SID and the calculation of a PBS.

“External data” are any other data that may be integrated in the bioinformatic tool.

“Bioinformatic tool” is a global term to refer to a computer system performing the method of the present invention. The bioinformatic tool comprises, but is not limited to, a database including the biological objects, an integration data tool (see section V.1), a data processing tool (see section V.2.) and a displaying tool (see section V.3).

The term “host” refers to the place wherein are generated the internal data, or example a laboratory or a company.

V.1. Data Integration

V.1.1. Internal Data Integration

The present invention relates to a method for constructing, representing or displaying protein interactions maps, it has been firstly developed and adapted with a particular biotechnology method: the Mating Two Hybrid System (see WO00/66722). The method also allows integration of data generated by other technologies such as multi-hybrid technologies (as described above in the Background), genomics technologies, proteomics technologies, 2D gel, mass spectrometry, protein profile expression, BRET technology, DNA chips, protein chips . . . .

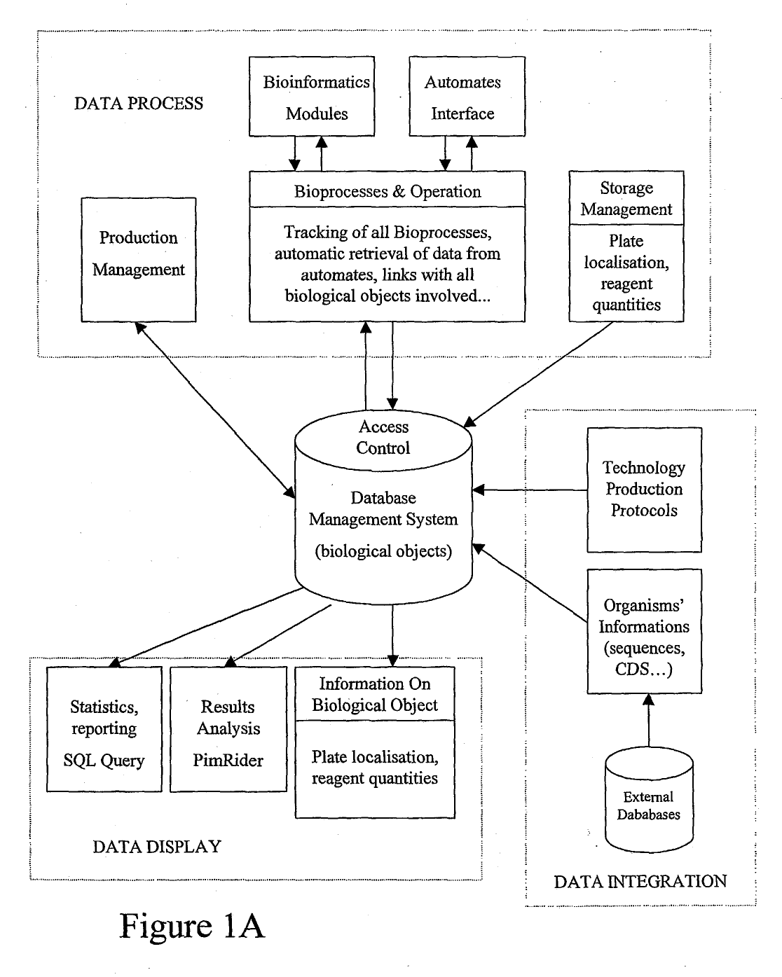

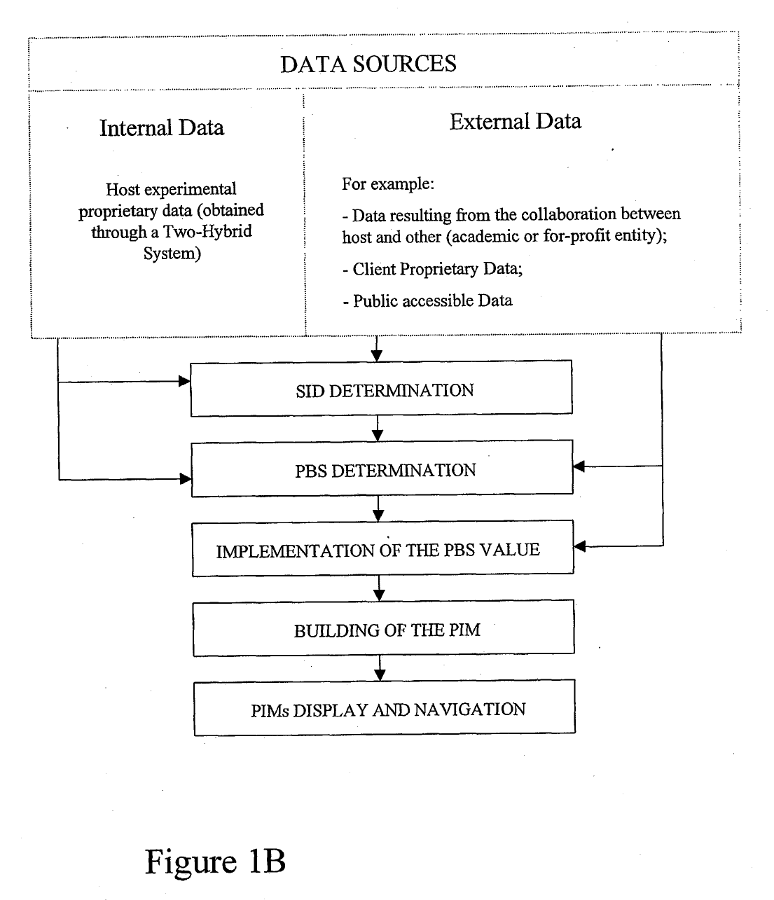

Data generated by the Mating Two Hybrid System lead to the identification of polypeptide prey fragments interacting with a given polypeptide bait fragment, these data are automatically integrated in the database. The repository of data is generated from a computerized production environment which supports and automates all the activities of host (Hybrigenics') Production Facilities (see FIG. 1A).

The database furthermore allows to manage and follow up the Mating Two Hybrid System running at high throughput scale (see Production Management on FIG. 1A) by the initiation of biotechnological programs, definition of processes and biotech/bioinformatics operations required by the technologies, enforcement of protocols, data acquisition and organized storage, automate interface, plate and biological material physical storage information, quality control, routine analysis of results.

The database has a functional architecture comprising the main following entities:

a Database Management System storing Biological Object (organism, protein, gene, sequence, ORF, CDS, fragment, plate, bait fragment-prey fragment interactions, protein-protein interactions, SID . . . );

BioProcess and Operation (such as Prey polypeptide-library construction in bacteria or in Yeast, Bait polypeptide cloning, Test-screening, selection of positive clones on Petri plates, Prey-fragment identification, cellular density and colour-based reporter gene activity measurement, plates reordering, 1-D agarose gel, sequencing . . . );

Technology Production Protocols;

and FIG. 1A shows generic relationships between these entities.

V.1.2. External Data Integration

In the specific case of data generated by the Two Hybrid System, the processing of data to define SID needs to compare identified prey polynucleotide sequences with sequences of each CDS or each ORF of the studied organism. For this purpose, it is needed to have access and to integrate whole organism's gene sequences in the database (see Data Integration module of FIG. 1A).

The present method also allows the integration of external data in addition to internal data.

In a specific aspect of the invention, the present method allows the construction of a protein interactions map exclusively with external data, external data may be extracted from literature.

These external data are used, for example, for the re-analysis of results when new external information are available, data mining, delivery of analysis results for the system.

External data may be extracted from:

user's private information:

user's annotation and data about interactions and proteins;

the use of generic interface, which can be customized, to format and access user's data;

regarding private data added by the user, PBS may be recalculated (PBS modelling and PBS computation).

public information:

There is no intrinsic limitations to the number of external databases, to their structure and to their data types that may be integrated in the database. Because PIMs are dense and homogeneous information networks, they can be used to formally model, interpret and analyze other data types and sources in an automatic or semi-automatic way, and thus provide some functional in-silico validations.

Example of sources of external data:

genome- or organism-specific databases (such as Pylorigene, Colibri, Subtilist, at http://genolist.pasteur.fr/, Yeast Protein Database at http://www.proteome.com/YPDhome.html) to get the details on any protein in the organism;

information about DNA, RNA and cDNA sequences (such as GenBank at http://www.ncbi.nlm.nih.gov/Genbank/index.html, EMBL at http://www.ebi.ac.uk/embl/index.html, or DDBJ at http://ftp2.ddbj.nig.ac.jp:8000);

protein annotations (such as SwissProt at http://www.expasy.ch/sprot);

protein sequence patterns and motifs (such as ProDom at http://www.toulouse.inra.fr/prodom.html);

protein families (such as Pfam at http://www.sanger.ac.uk/Software/Pfam/index.shtml);

3D structures (such as PDB at http://pdb-browsers.ebi.ac.uk);

protein domain (such as Prosite);

bibliographical references (such as Medline);

Phylogeny;

Metabolic Pathways (such as KEGG or EcoCyc);

Signaling Pathways;

gene expression profiles;

protein expression profiles;

phenotypic and mutation analysis;

SNPs;

EST (such as dbEST, http://www.ncbi.nlm.nih.gov/dbEST);

tissue-specific or pathology-specific information;

cell-wide processes and dynamics;

physico-chemical properties and affinity-related information;

patent databases;

cellular localization;

cellular dysfunctions.

V.1.3. Structure of the Bioinformatic Tool

The system software architecture includes:

a multi-layered web architecture, each layer being able to be physically distributed on separate hardware and scaled independently,

an (object-relational) database management system,

a data base object and structure,

an object-oriented language (Java) to implement the business-object layer,

the SQL language to access the databases,

a middleware layer (currently implemented with Java Server Page (JSP)) to process users' request and to generate on the fly the HTML pages of the user interface

a set of applications to perform specific tasks on Host (Hybrigenics') servers

a set of applications and applets to perform specific tasks on the client's machine

a set of visualization and display screens accessible through a WWW browser

V.1.4. Annotation

The bioinformatic tool can manage user demand routine that reports a set of data regarding a biological object of interest from a given external database into the database.

V.2. Data Process

The present invention also proposes a data processing tool comprising computerized means adapted for the processing of the above mentioned methods.

In particular, it proposes a bioinformatics tool for storing and manipulating biological or proteomic data, wherein the data are analyzed and processed to construct protein interactions maps.

V.2.1. The Construction of the PIM

The bioinformatic tool of the present invention, that may be based on a relational database but also flat files (e. g., xml files), collects Two-Hybrid results directly after the biological assays and stores all these results to construct the protein network.

A PIM is represented in a graph in which proteins are represented by nodes and interaction between these protein are represented by links.

V.2.2. The Determination of the Predicted Biological Score (PBS)

The Predicted Biological Score (PBS®) is Hybrigenics' reliability score for protein-protein interactions derived from yeast two-hybrid screenings. The aim of the PBS computation is to add value to the generated Protein Interaction Maps (PIMs) by filtering out false positives and rescuing false negatives.

The Predicted Biological Score sums up the reliability of the interaction according to the present state of our biological knowledge. The PBS score computation relies on several different levels of analysis: a local (that is, taking into account only the results of one screen) internal score is computed for each screen; and then, a global internal score is computed from the local scores by integrating results from all screens performed within the same library. Local scores are thus computed only once, while global scores are recomputed each time new screens are performed.

Optionnally, an external PBS score may be calculated.

1. The internal PBS is computed using only Hybrigenics' proprietary data, i.e. from the high throughput screening results. The computation features two steps:

The local internal PBS, derived from each individual screen, is a reliability score for bait-to-prey oriented interactions. It is based on a statistical model of the experimental process, modified by some biological expertise driven post-processing. For each screen, positively selected fragments are clustered in order to define Selected Interacting Domains (SIDs). Fragments that have no or very improbable coding capability (antisense, intergenic region, and out-of-frame fusion fragments selected in a single frame) are eliminated. The SIDs thus define patterns for potentially matching fragments a posteriori.

The probability of randomly selecting the fragments that define an interaction SID can be computed from the fragment distribution in the initial prey library. Assuming that prey fragments compete for the bait with ‘equal chances’, the probability p for a given fragment to be selected in an experiment is proportional to its expected number of occurrences within the library. p is computed as a function of the fragment length and position, and of the length and position distributions of fragments in the prey library (these distributions are calibrated using data from random sequencing).

The local PBS is the probability for a given SID to be obtained under the equal chance hypothesis, that is, as a result of random noise. It is deduced by combining probabilities p (using a binomial law) from each of the independent fragment defining it. It is expressed as an E-value probability ranging from 1 (artefact) to 0 (significant).

Global internal PBS: Biological expertise may modify this initial score by applying strategies to deal with specific cases, like the presence of antisense, intergene or out-of-frame fragments.

A (global) PBS is computed for each protein interaction after pooling results from all screens. First, bait and SID (prey) fragments representing the same region are clustered together. On the basis of an independence hypothesis, scores from different screens are then combined together when the same protein domain pair is involved. The resulting PBS thus represents the probability that the protein-protein interaction is due to noise. Finally, connectivity patterns are examined to detect abnormally connected regions. In particular, sticky domains are detected and their PBS is set to 1 (E, see below): a sticky domain is a SID that was found in an unexpectedly high number of screens, and corresponds to a strongly connected prey vertex in the PIM. Unsuccessful screens/baits, leading to oriented interactions with local PBSs close to 1 (minimum), are dismissed as well.

Scores are real numbers ranging from 0 to 1, but are grouped for practical purposes in five categories ranging from A (high significance) to E (low significance).

2. External PBS are interaction scores derived from external information such as SID sequence analysis, bibliographical data, in vivo expression assays, additional biological validations or 2-hybrid data from external sources. External data are, automatically or manually, obtained from mining of public databases.

Both the intercategory thresholds and the high-connectivity threshold were defined manually, taking into account the nature of the studied organism, the relevant library and the current coverage of the proteome (A<1e-10<B<1e-5<C<1e-2.5<D; the E category corresponds to prey SIDs selected with more than 4 baits and was arbitrarily attributed a PBS value of 1).

The PBS score is presented as an unique score resulting from the combination of the internal PBS and each of the external PBS available for a given protein-protein interaction. However, the trace of each intermediary PBS is kept to help interpretation. Moreover, in order to facilitate understanding and usability as selection criteria in the PIM Rider, the PBSs are regrouped intro five categories from A (high significance) to E (low significance).

V.2.3. The Determination of the Selected Interacting Domains (SID®)

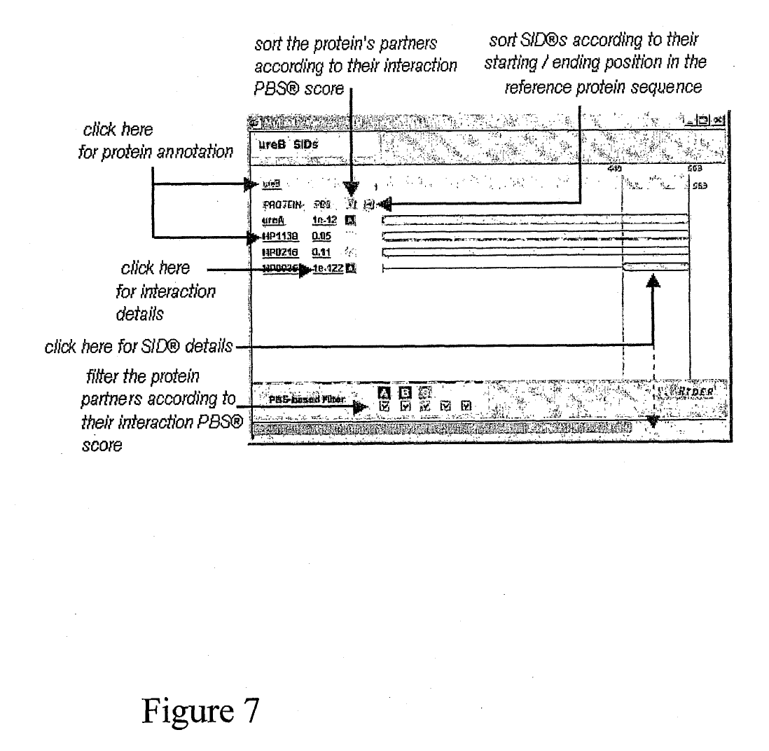

It will be understood that the bioinformatic tool provided in the present invention allows the determination of the Selected Interaction Domain which is the smallest polypeptide fragment known to interact with a given protein Cf. example 5 and FIG. 7 of Hybrigenics' Patent Application WO 00/66722.

V.2.4. Reprocessing of Data

Each interaction's PBS may be adjusted depending on the global PIM structure (i.e. all the other interactions from all other screens). For example, a protein interacting with a large number of neighbours may represent an experimental artefact (a false positive) and the PBS of the interactions involving this protein are then increased towards the value 1; example: if a weakly-connected protein interacts with two other functionally-related proteins, the chance for these interactions to be artefactual is reduced and their PBS is then decrease towards the value 0.

V.3. The Displaying Tool

V.3.1. Interaction Viewer

The present invention proposes a PIM visualising tool which offers to the user the following capabilities:

exploration of protein interaction maps;

comparison between different protein interaction maps.

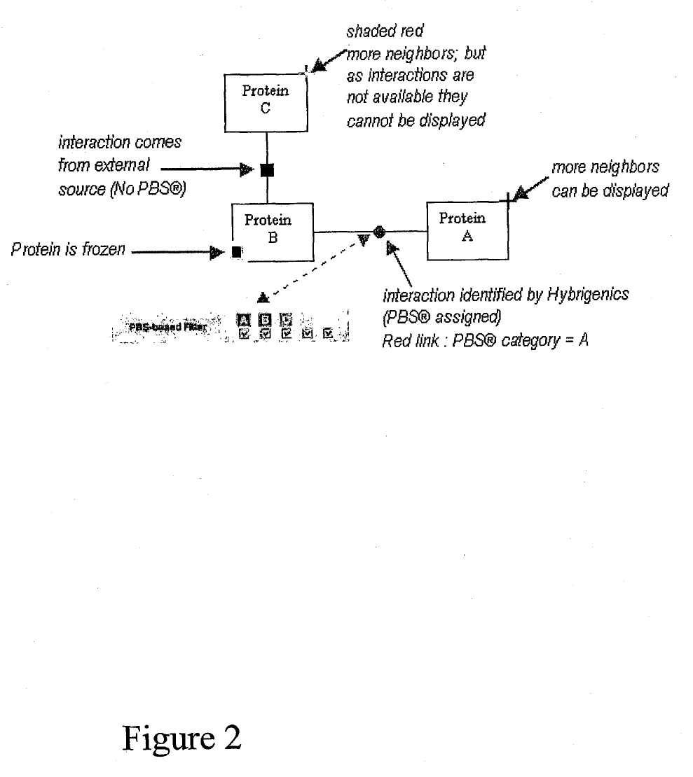

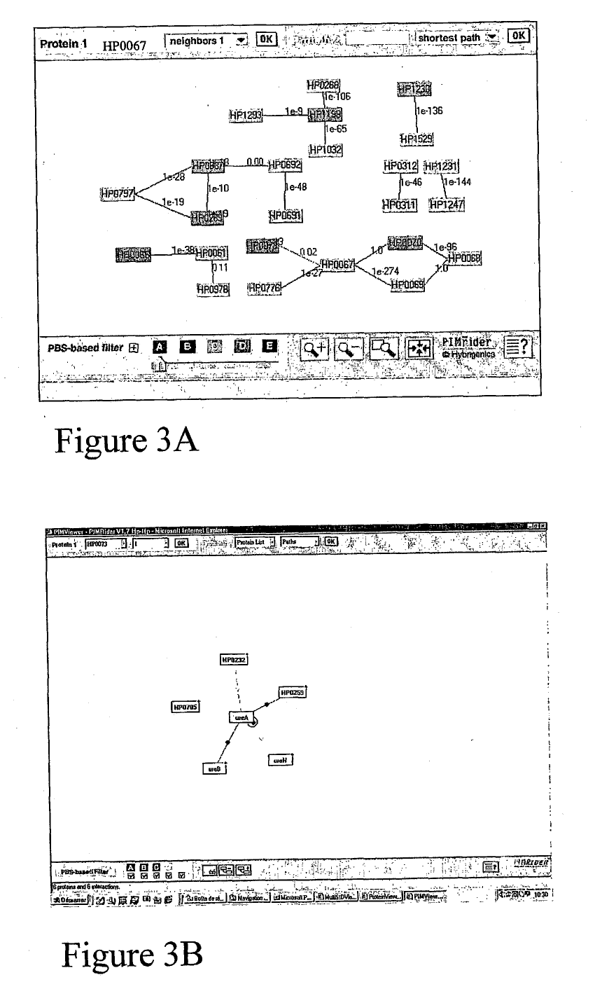

The invention proposes an interaction map representation method in which references of proteins are represented with links corresponding to alleged interactions between said proteins, wherein a score representing the significance of the protein-protein interaction is determined for each interaction and the scores of the represented interactions are indicated on the interaction map in the vicinity of the interactions to which they correspond (see FIGS. 2, 3A and 3B).

The invention also proposes an interaction map representation method in which references of proteins are represented with links corresponding to alleged interactions between said proteins, wherein a score representing the significance of the protein-protein interaction is determined for each interaction and wherein the representation of the interaction links is filtered as a function of said score.

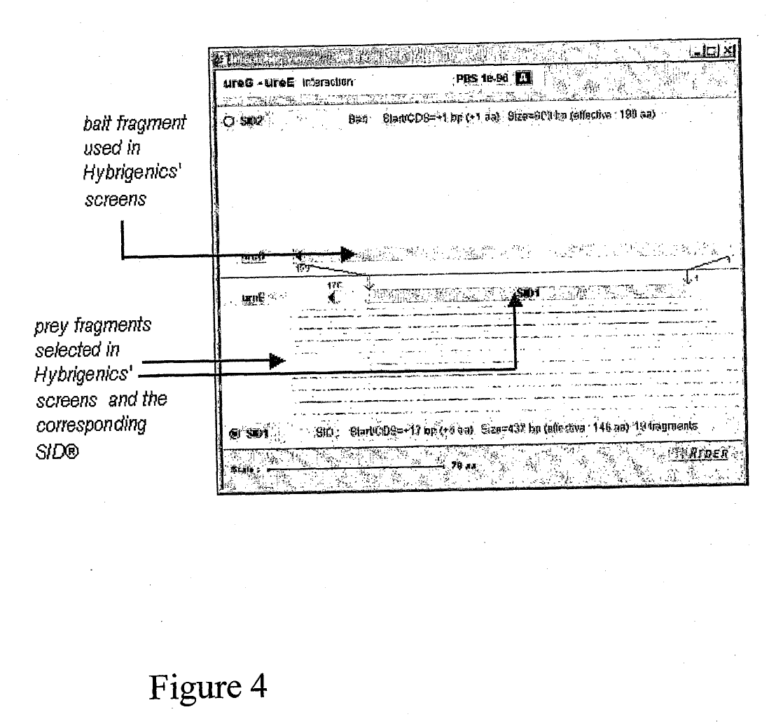

The present invention allows the visualisation of the localisation on the complete CDS or on the full-length protein of every prey polynucleotide or polypeptide fragments, respectively, identified as interacting with a given bait polypeptide in the Two Hybrid System, or in every technologies leading to the identification of two interacting polypeptides (see FIG. 4).

The present invention allows the displaying of several PIMs of different organisms in order to compare specific pathways or global PIMs.

For the comparison of pathway from different organisms, the bioinformatic tool shall underline the percentage of identity between the proteins of the two different organisms involved in the pathway.

The bioinformatic tool can perform PIM inference, based on sequence homologies with an existing PIM used as a reference.

The following list shows examples of PIM visualization, manipulation and exploration:

the selection, search, retrieval and display of proteins and genes based on annotations, keywords, functional classification codes, protein or DNA sequence, and accession number of external databases;

the retrieval of existing PIMs;

the display of PIMs represented as valued graphs containing up to tens of thousands of proteins and protein interactions;

the retrieval and display of a synthetic set of information about any protein in the organism;

the retrieval and display of the details of any interaction in the PIM; these details include the bait protein, the prey protein, the SIDs and the fragments (number, size and location) used to compute the PBS;

the retrieval and display of a protein's neighbours at multiple levels (if they exist).

V.3.2. SID Viewer

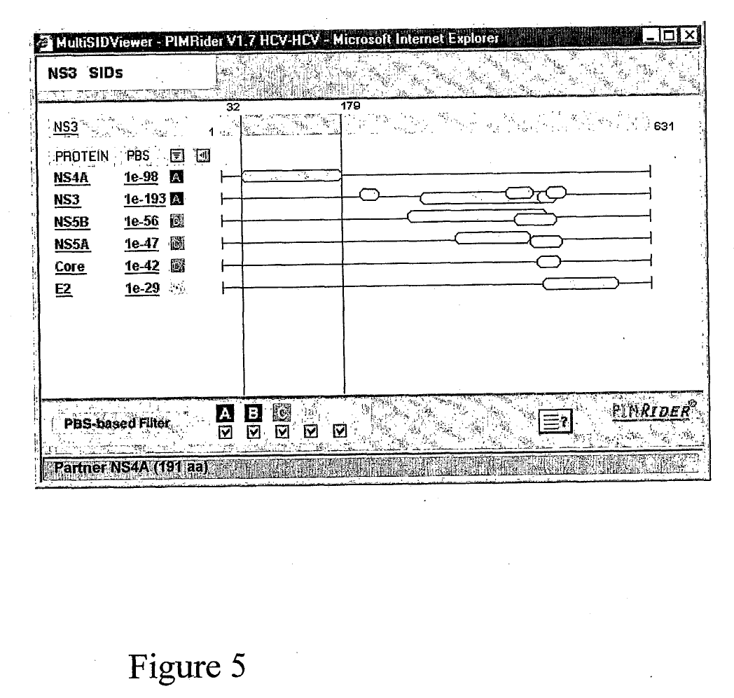

Furthermore, the present invention allows the visualisation of the localisation on the complete CDS or on the full-length protein (primary structure) of the SID polynucleotide sequence or polypeptide sequence, respectively, defined by comparison of the prey fragments common to a given CDS (FIG. 5).

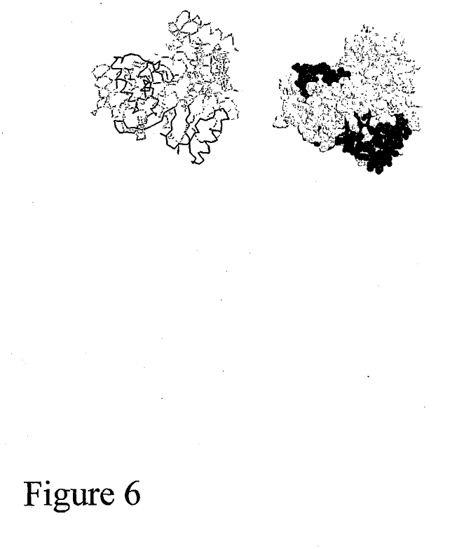

Another functionality is the representation of the 3D structure of the SID alone, or the representation of the 3D structure of the whole protein with a specific colour to visualise the localisation of the SID in the protein (see FIG. 6).

Multi-SID Viewer

A given protein may be involved in several interactions with different proteins, the present invention allows the visualisation of the localisation on the CDS or on the full-length protein of all the SID corresponding to each interaction (see FIG. 5 and FIG. 7).

Other examples of functionality of the present invention are the following:

one can select a link on the screen (for example, through a click) and obtain a new screen displaying information relating to SIDs corresponding to said link. For example, the new screen may display selected preys fragments which have lead to the determination of the Selected Interacting Domain. The displaying tool comprises means for selecting a protein on the screen and for obtaining a new screen displaying all the SIDs and their amino-acid sequence locations corresponding to said protein, on this new screen, information about a protein or list of proteins can be displayed, with the ability to search for one or several proteins based on various criteria.

on the screen displaying SID, a clickable link may lead to a new screen displays selected preys fragments which have lead to the determination of the selected interacting domain.

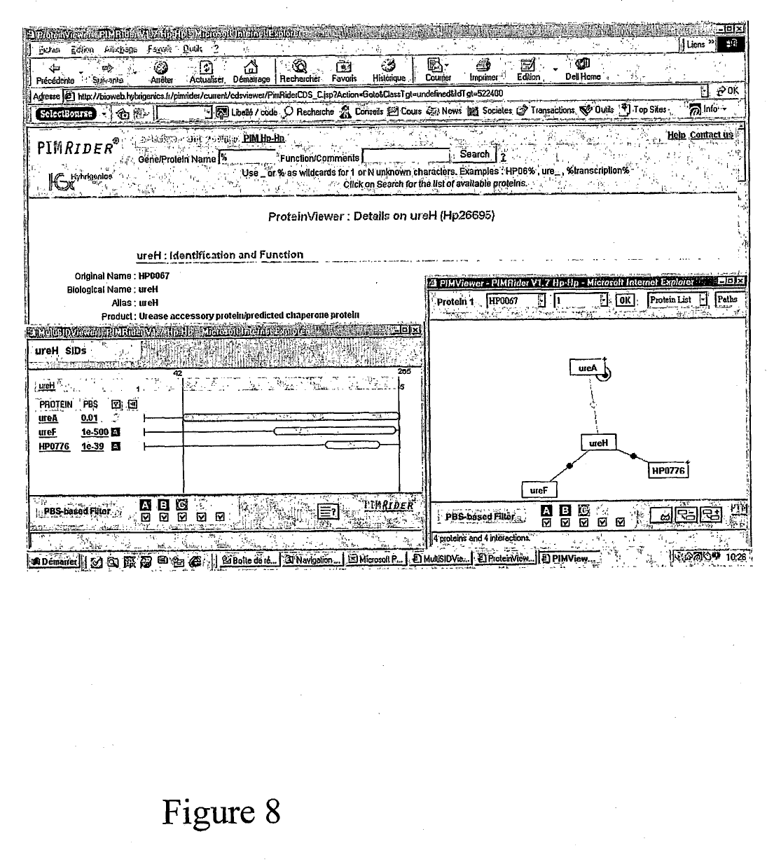

All the different functionalities described in section V.3.1. and in section V.3.2. may be visualised simultaneously on the same screen: see for example FIG. 8.

V.3.3. Optimisation of the Graphical Representation of the PIM

Representation of the PIM is performed with an automatic and optimized real-time placement of proteins so as to minimize the number of overlapping proteins and the number of interaction crossings.

The bioinformatic tool offers the ability to zoom in, zoom out, zoom on a user-selected zone of the PIM, make the PIM fit the size of the current application window, resize the interactions so as reduce the total space taken by the PIM on the application window, resize the interactions according to the PBS values so as to put the put closer the proteins which are likely to be real biological partners.

V.3.4. Adaptable Features of the Bioinformatic Tool by the User

The user can personalise the graphical representation of the PIM with:

the parametrization of proteins and interactions: label, color, width and shape;

he can “freeze” (immobilise) proteins and interactions on screen, deletes protein he does not want to study.

If the PIM comprises too much information, the displaying tool allows the user to focus the map on a specific protein or on a group of proteins by using a “magnifying glass-like” representation. This mode of visualisation enlarges the zone of interest and reduces other parts of the map.

User may also use the PBS filtering property to improve the graphical representation of the PIM with:

the filtering, retrieval and display of PIMs based on PBS categories or values;

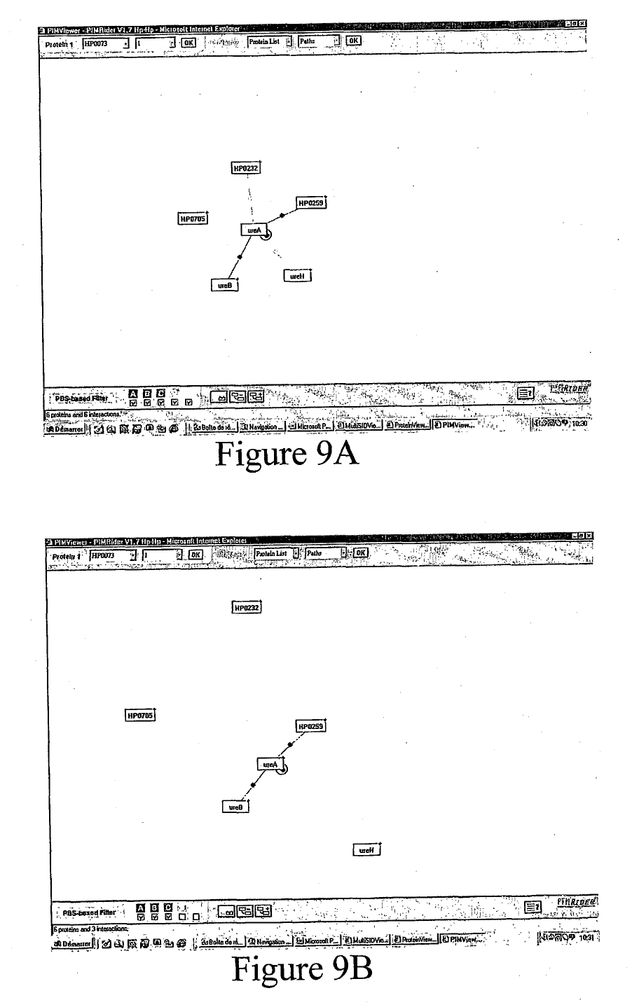

the optional display of the PBS value for each of the visualized interactions (each interaction being also coloured according to its PBS category) (see FIGS. 9A and 9B).

V.3.5. User Project Management

In order to perform its exploration of a PIM, the user can focus its request on a specific protein and/or the interaction or group of proteins and/or interactions, he can also define a specific polypeptide domain and search in which protein and pathway this domain is present.

User can also artificially cluster interactions between proteins of his interest, the bioinformatic tool offers the possibility to filter these interaction according to their origin, for example, user will be able to request a selection of interaction obtained with the Two-Hybrid System or extracted from the literature.

The user can annotate proteins and interactions with its own data.

Beyond the functionality of the present invention, the bioinformatic tool permits the management of projects, the access to specific data to work groups with, for example, different level of permissions.

The bioinformatic tool of the invention helps users in:

identifying and classifying the interaction modulators, including enhancers and inhibitors;

reconstructing of biochemical pathways;

inference of interaction pathways in fully or partially sequenced genomes, included in the human genome;

the retrieval and display of the interaction pathway between different user-selected proteins (if they exist); criteria for the selection of pathways include the ‘starting’ node, the ‘ending’ protein, the total number of participating protein and the PBS values of the constitutive edges.

As described above, the bioinformatic tool allows the optimization of screenings by selecting the most appropriate genes and proteins based on global topology of the protein network and its local connectivity and contributes to the management of the Two Hybrid running in high throughput.

The security of the access may be assured with authentication of users and groups, but also by tracking of on-going user's tasks and actions and reporting on the results and synthetic displays.

For each user, the results of PIM exploration may be loaded and saved in different formats such as proprietary, text, HTML, XML or tab-delimited files, these results, project synthesis and PIMs may also be printed.

### VI EXAMPLES

These examples are also available in the article “The protein-protein interaction map of Helicobacter pylori” (Rain et al., 2001)

VII. BIBLIOGRAPHY

Field, S. and Song, O., 1985, “A novel genetic system to detect protein-protein interaction”, Nature, 340, 245-246.

Jones, P. B. C., 2000, “The commercialisation of bioinformatics”, Electronic Journal of Biotechnology, 3(2).

Blackstock, W. P. and Weir, M. P., 1999, “Proteomics: quantitative and physical mapping of cellular proteins”, Tibtech, 17, 121-127.

Fromont-Racine, M., Rain, J.-C. and Legrain, P., 1997, “Toward a functional analysis of the yeast genome through exhaustive two hybrid screens”, Nature Genetics, 16, 277-282.

Tirode et al., 1997, “A conditionally expressed third partner stabilises or prevents the formation of a transcriptional activator in a three hybrid system” Journal of Biological Chemistry, 272, 22995-22999.

Vidal et al., 1996, “Reverse two-hybrid and one-hybrid system to detect dissociation of protein-protein and DNA protein-interactions”, Proc. Natl. Acad. Sci. USA, 93, 10315-10320.

Ladant et al., 1998, Proc. Natl. Acad. Sci. USA, 95, 5752-5756.

Xenarios, I. et al., 2000, “DIP: the database of interacting proteins”, Nucleic Acids Res., 28, 289-291.

Wei, Z. et al., 1999, Mol. Cell. Biol., 19(2), 1271-1278.

Zhang, B. et al. 1997, (eds), “The yeast Two-Hybrid System”, Oxford University Press, New York, N.Y., pp.298-315.

Licitra, E. J. et al., 1996, Proc. Natl. Acad. Sci. USA, 93, 8496-8501.

Vidal, M. and Legrain, P., 1999, Nucleic Acids Research, 27(4), 919-929.

Rain J.-C., et al., 2001, “The protein-protein interaction map of Helicobacter pylori”, Nature, 409, 211-215.

WO00/66722 patent application filed on Apr. 4, 2000.

What we claim is:

1. An interaction map construction and representation method in which references of proteins are represented with links corresponding to alleged interactions between said proteins, wherein a score representing the significance of the protein-protein interaction is determined for each interaction and the scores of the represented interactions are indicated on the interaction map in the vicinity of the interactions to which they correspond.

2. An interaction map construction and representation method in which references of proteins are represented with links corresponding to alleged interactions between said proteins, wherein a score representing the significance of the protein-protein interaction is determined for each interaction and wherein the representation of the interaction links is filtered as a function of said score.

3. A method according to claims 1 or 2 in which the representation is displayed on a computer screen.

4. A method according to claim 3 in which one can select a link on the screen and obtain a new screen displaying information relating to selected interacting domain corresponding to said link.

5. A method according to claim 4 in which the new screen displays selected preys fragments which have lead to the determination of the selected interacting domain.

6. A method according to any of the preceding claims in which the score is computed as a combination of one or more “component scores”.

7. A method according to claim 3 in which one can select a protein on the screen and obtain a new screen displaying all the SIDs and their amino-acid sequence locations corresponding to said protein

8. A method according to any of the preceding claims in which an internal score using only the Host proprietary data is computed.

9. A method according to claim 7 in which the internal score is computed in two steps:
determination of a local internal score derived for each protein-protein link
determination of a global internal score combining local internal scores.

10. A method according to any of the preceding claims in which a score is a probability value.

11. A method according to any of the preceding claims in which an external score using data from outside sources is computed.

12. A method according to any of the preceding claims in which information about a protein or list of proteins are displayed, with the ability to search for one or several proteins based on various criteria.

13. A data processing tool comprising computerized means adapted for the processing of the method according to any of the preceding claims.

14. Bioinformatics tool for storing and manipulating biological (proteomic) data, wherein the data are analyzed and processed to construct protein interactions maps according to any of claims 1 to 12.

15. A data processing tool according to claim 13 or 14 in which references of proteins are displayed with links corresponding to alleged interactions between said proteins and comprising means for the determination of a score representing the significance of the protein-protein interaction for each interaction.

16. A data processing tool according to claim 15 comprising means for displaying the interaction links with a filtering as a function of said score.

17. A data processing tool according to claim 16 comprising means for selecting a link on the screen and displaying a new screen displaying information relating to selected interacting domain corresponding to said link.

18. A data processing tool according to claim 17 in which the new screen displays selected preys fragments which have lead to the determination of the selected interacting domain.

19. A data processing tool according to any of the preceding claims in which the score is computed as a combination of one or more “component scores”.

20. A data processing tool according to claim 17 in which one can select a protein on the screen and obtain a new screen displaying all the SIDs and their amino-acid sequence locations corresponding to said protein

21. A data processing tool according to any of the preceding claims in which an internal score using only the Host proprietary data is computed.

22. A data processing tool according to claim 21 in which the internal score is computed in two steps:
determination of a local internal score derived for each protein-protein link
determination of a global internal score combining local internal scores.

23. A data processing tool according to any of the preceding claims in which a score is a probability value.

24. A data processing tool according to any of the preceding claims in which an external score using data from outside sources is computed.

25. A data processing tool according to any of the preceding claims in which information about a protein or list of proteins are displayed, with the ability to search for one or several proteins based on various criteria.
